(19) United States
(12) Patent Application Publication
(10) Pub. No.: US 2021/0239195 A1
(43) Pub. Date: Aug. 5, 2021

(54) Mechanism for Adjusting Tension of Flexible Transmission Component

(71) Applicant: DYNACOLOR, INC., Taipei (TW)

(72) Inventors: Warren Chen, Taipei (TW); Bo-Ruei Huang, Taipei (TW); Chung-Hsing Wang, Taipei (TW)

(21) Appl. No.: 16/780,907

(22) Filed: Feb. 4, 2020

(51) Int. Cl. F16H 7/14

(52) U.S. Cl. CPC F16H 7/14; F16H 2007/0842

(57) ABSTRACT

A mechanism for adjusting the tension of a flexible transmission component, comprising: a driver; a follower, with a center distance between the center of the driver and the center of the follower; a flexible transmission component, which is a closed loop passing around the driver and the follower; a first base connecting with the driver, wherein aid first base can move in a direction of movement parallel to the center distance and away from and/or forward to the follower; a second base connecting with the follower; and at least one elastic component connecting the first base and the second base.

### FIELD OF THE INVENTION

The present disclosure relates to a mechanism for adjusting the tension of a flexible transmission component, especially a mechanism adjusting the tension of a flexible transmission component by at least one elastic component.

### BACKGROUND OF THE INVENTION

Flexible transmission means the transmission using a flexible connector having a soft and easily bending texture as a transmission component, and transmitting the force from a machine element to another machine element through the tension of the transmission component. The mechanism of flexible transmission usually includes a driver, a flexible transmission component, and a follower. The driver is the machine element for outputting the force, or the machine element that directly receives the force and firstly operates, such as a motor. The flexible transmission component is the machine element for transmitting the force from the driver to the follower by tension, such as a belt, a rope, or a chain. The follower is defined as any moveable machine elements moved by the driver in the transmission mechanism except the flexible connector, such as a pulley or a chain wheel, wherein the follower can be in mesh with the flexible connector.

Conventionally, the tension of the flexible transmission component may be not high enough for transmitting the force from the driver to the follower. The tension is produced after the flexible transmission component is passing around the driver and the follower, and it results from the distance between the center of driver and the center of follower (i.e., “center distance”). The tension is also known as the tightness, so the situation that tension of the flexible transmission component is not high enough to transmit the force from the driver to the follower is also known as “the level of tightness is not high enough” or “loose”.

Many reasons may lead to the situation that the level of tension of the flexible transmission is not high enough, such as: (1) the center distance is relatively too short to the flexible transmission component; (2) the assembly tolerance results in that the center of the chain wheel is not the rotation center of the chain wheel, so the distance between the center of the chain wheel and the center of the driver (i.e., the center distance) changes over the rotation of the chain wheel; (3) the flexible transmission component operates in a fatigue status due to a heavy load; (4) the flexible transmission component is fatigue; and the like.

The inadequate tension of the flexible transmission component may lead to that the flexible transmission component and the chain wheel mesh poorly, thereby deteriorating the sliding phenomenon happened between the flexible transmission component and the chain wheel. The sliding phenomenon dissipates the power transmitted by the flexible transmission component, hence the rotation of the follower won't achieve the expected rotation angle calculated in accordance with the output of the driver.

To solve the problem caused by inadequate tension of the flexible transmission component, at least one idler may be installed in contact with the slack side of the flexible transmission component in any of the following situations: (1) the center distance between the driver and the follower is relatively too short to the flexible transmission component and nonadjustable; (2) an obstacle appears between the driver and the follower; (3) a larger contacting area between the pulley and the flexible transmission component is needed; and (4) the flexible transmission component vibrates because of a longer center distance between the driver and the follower.

However, installation of an idler in the transmission mechanism may lead to the following problems: (1) the service life reduction of the flexible transmission component because a force is applied on the bending flexible transmission component; and (2) the demand of the extra cost for assembling and the extra space for arranging the additional idler.

Hence, it is necessary to provide a mechanism for adjusting the tension of the flexible transmission component to resolve above problems, in which the mechanism has a longer service life of the flexible transmission component, a lower cost for assembling, and a less space demand.

### SUMMARY OF THE INVENTION

To resolve the above problems in prior art, the present disclosure provides a mechanism for adjusting the tension of a flexible transmission component, in which the mechanism has at least one elastic component with a restoring ability between the machine elements which can move relatively to each other, and these machine elements connect with the flexible transmission component directly or indirectly.

When the flexible transmission component loosens, the restoring force of the elastic component makes the distance from the driver to the follower change, and the tension of the flexible transmission component can by adjusted through this change. This mechanism does not increase the force applied on the bending flexible transmission component, and does not need an extra space for arranging additional machine elements.

The present disclosure provides a mechanism for adjusting the tension of flexible transmission component, comprising: a driver; a follower, with a center distance between the center of said driver and the center of said follower; a flexible transmission component, which is a closed loop passing around said driver and said follower; a first base connecting with said driver, wherein said first base can move in a direction of movement parallel to said center distance and away from and/or forward to said follower; a second base connecting with said follower; and at least one elastic component connecting said first base and said second base, and said at least one elastic component is arranged between said driver and said follower.

The initial status means that the flexible transmission component is not relatively too long to the center distance. The flexible transmission component in the initial state is not loose, and the transmission of the motion or the power of the driver is not influenced due to loosening.

When the length of the flexible transmission component is relatively longer than that in the initial status, the flexible transmission component is loose, and the restoring force of the elastic component between the first side of the first base and the second base will make the first base (and the driver connected therewith) and the follower move relatively to each other; in which the first base and the driver therewith move in the direction parallel to the center distance and away from the follower, and the center distance between the driver and the follower becomes longer than the center distance in the initial state. This change of the center distance resolves the problem due to loosening of the flexible transmission component.

Hence, the transmission mechanism of the present disclosure can adjust the relative position of machine elements by the restoring force of the elastic element to maintain an adequate tension of the flexible transmission component. This avoids the deterioration of loosening and sliding phenomenon, and minimizes the power consumption during the force transmission of the flexible transmission component.

To resolve the above problems present in prior art, the present disclosure provides another mechanism for adjusting the tension of a flexible transmission component. The mechanism has an elastic component with a restoring ability arranged between the machine elements which can move relatively to each other and connect with the flexible transmission component directly or indirectly. When the flexible transmission component is loose, the relative position of the machine elements will be adjusted by the restoring force of the elastic component, and the tension of the elastic component will also be adjusted by the relative position. This mechanism does not increase the force applied to the bending flexible transmission component.

The present disclosure provides another mechanism for adjusting tension of flexible transmission component, comprising: a driver; a follower, with a center distance between the center of said driver and the center of said follower; a flexible transmission component, which is a closed loop passing around said driver and said follower; a first base connecting with said driver, wherein aid first base can move in a direction of movement parallel to said center distance and away from and/or forward to said follower; and at least one elastic component connecting said first base and said second base, and said driver is arranged between said follower and said at least one elastic component.

In some embodiments of the present disclosure, the present disclosure provides the mechanisms could be applied to a PTZ camera.

In some embodiments of the present disclosure, the driver is a motor selected from an electric motor, or a stepper motor.

In some embodiments of the present disclosure, the follower is a chain wheel, or a gear.

In some embodiments of the present disclosure, the flexible transmission component is a rope, or a belt.

In some embodiments of the present disclosure, the elastic component is a spring, such as an expansion spring or a compression spring.

In some embodiments of the present disclosure, the first base is a moveable platform.

### BRIEF DESCRIPTION OF THE DRAWINGS

FIG. 1 represents a schematic diagram of a typical flexible transmission mechanism.

FIG. 2(a) and FIG. 2(b) represent the schematic diagrams of another typical flexible transmission mechanism.

FIG. 3 represents a schematic diagram of one example of the mechanism for adjusting the tension of a flexible transmission component disclosed in the present disclosure.

FIG. 4 represents a schematic diagram of another example of the mechanism for adjusting the tension of a flexible transmission component disclosed in the present disclosure.

### DETAILED DESCRIPTION OF THE INVENTION

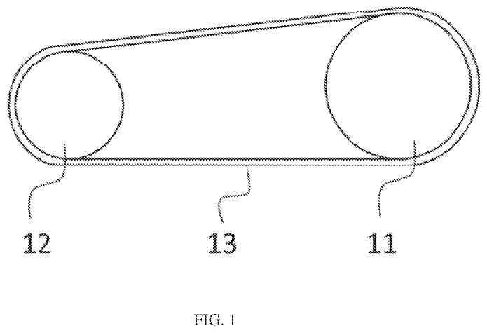

FIG. 1 represents the schematic diagram of the typical flexible transmission mechanism 1 including two machine elements and a flexible transmission component 13, in which the two machine elements are a driver 11 and a follower 12. The driver 11 directly receives the force and firstly rotates. The follower 12 indirectly receives the force, which is transmitted by the tension (i.e., tensile force) of the flexible transmission component 13, to rotate. However, the typical transmission mechanism 1 has a disadvantage: the flexible transmission component 13 cannot carry forward the follower 12 smoothly when the flexible transmission component 13 loosens or the sliding phenomenon happened between the flexible transmission component and the chain wheel.

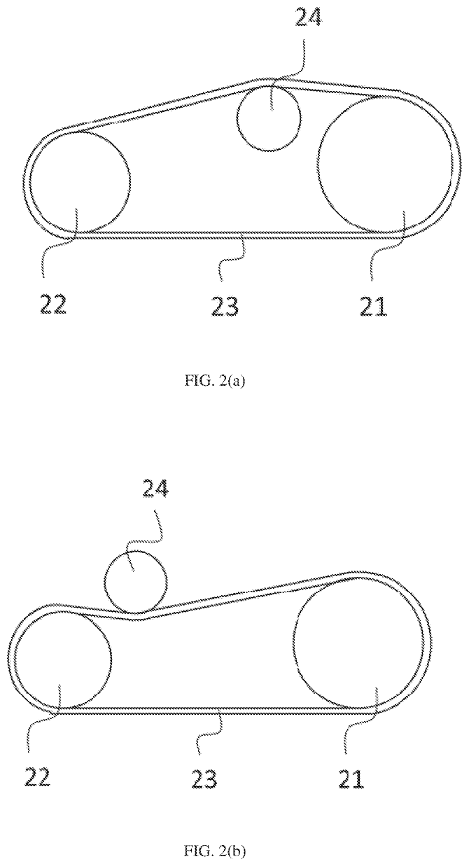

FIG. 2(a) and FIG. 2(b) show the schematic diagrams of another typical flexible transmission mechanism 2 including: two machine elements, a flexible transmission component 23, and an idler 24, in which the two machine elements are a driver 21 and a follower 22. The driver 21 directly receives the force and firstly rotates. The follower 22 indirectly receives the force, which is transmitted by the tension (i.e., tensile force) of the flexible transmission component 23, to rotate. The idler 24 is installed in contact with the slack side of the flexible transmission component 23 (such as the inner side of the flexible transmission component as shown in FIG. 2(a), or the outer side of the flexible transmission component as shown in FIG. 2(b)) to adjust the tension of the flexible transmission component 23 by increasing the force applied on the bending flexible transmission component 23, thereby resolving the problems from the loosening of the flexible transmission component 23. However, the flexible transmission mechanism 2 has disadvantages: (1) the service life reduction of the flexible transmission component 23 due to additional force applied on the bending flexible transmission component; (2) the demand of additional machine elements for assembling the idler 24; (3) the demand of additional space for installing the idler 24; and (4) the demand of the extra cost for assembling the idler 24 because additional machine elements are needed. Hence, the conventional flexible transmission mechanism 2 needs a higher cost, a greater demand of space and a shorter service life.

The present disclosure, however, provides a mechanism for adjusting the tension of a flexible transmission component by at least one elastic component, which has a longer service life, a lower cost and a reasonable space demand.

### Examples

Although the present disclosure has been described in the following examples, it should be understood that various modifications, additions and alterations may be made to the present disclosure by one skilled in the art without departing from the spirit and scope of the present disclosure as defined in the appended claims.

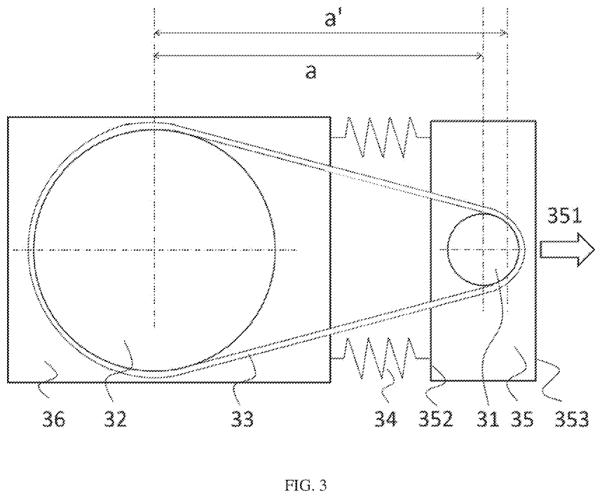

FIG. 3 represents a schematic diagram of the top view of the transmission mechanism 3, which includes: a driver 31, a follower 32, a flexible transmission component 33, elastic elements 34, a first base 35, and a second base 36, in which a center distance (a) is defined as the distance between the center of the driver 31 and the center of the follower 32, a direction of movement 351 is defined as the direction parallel to the center distance (a) and away from the follower 32. The first base 351 can be divided by a fictitious median line passing through the center of the first base 35 and perpendicular to the direction of movement 351 (shown as a dot-dashed line in the figure) into two sides: a first side 352 and a second side 353, which located on the bilateral sides of the median line. The first side 352 is the side of the first base 35 closer to the follower 32, and the second side 353 is the other side of the first base 35, which is farer to the follower 32. The driver 31 is connected to the first base 35, and the follower 32 is connected to the second base 36. The flexible transmission component 33 is a closed loop passing around the driver 31 and the follower 32. The elastic components 34 connect the first side 352 of the first base 35 and the second base 36, and the elastic components 34 are arranged between the driver 31 and the follower 32 (as shown in FIG. 3).

In this example shown in FIG. 3, the driver 31 is the first machine element that directly receives the force and firstly rotates. The follower 32 indirectly receives the force, which is transmitted by the tension (i.e., tensile force) of the flexible transmission component 33, to rotate. The elastic components 34 connect the first side 352 of the first base 35 and the second base 36, and the elastic components 34 are in a compression status due to the forces from the first base 35 and the second base 36.

In the situation that the first base 35 is moveable, when the flexible transmission component 33 loosens, the elastic components 34 will drive the first base 35 and the driver 31 connected therewith move in the direction of movement 351 and away from the follower 32 by the restoring force of the elastic components 34. At this time, a longer center distance (a′) between the center of the driver 31 and the center of the follower 32, which is longer than the original center distance (a), is formed, and the flexible transmission component 33 can adjust its tension to an adequate status at any time because of the restoring force of the elastic components 34.

In the transmission mechanism 3, the elastic components 34 are arranged between the first base 35 (and the driver 31 therewith) and the second base 36 (and the follower 32 therewith), so the tension of the flexible transmission component 33 can be adjusted by adjusting the center distance between the driver 31 and the follower 32, such as from the center distance (a) to the center distance (a′). Therefore, the transmission mechanism 3 resolves the problem that the flexible transmission component loosens in the prior art without increasing the force applied on the bending flexible transmission component.

Moreover, in the example shown in FIG. 3, the driver 31 comprises, but not be limited to, a motor, such as an electric motor or a stepper motor; the follower 32 comprises, but not be limited to, a chain wheel or a gear; the flexible transmission component 33 comprises, but not be limited to, a rope or a belt; and the elastic components 34 comprise, but not be limited to, a spring, such as a compression spring or an extension spring.

The conventional technique, such as the transmission mechanism shown in FIG. 2(a) and FIG. 2(b), arranges an idler 24 in the flexible transmission mechanism 2 to resolve the problem due to loosening of the flexible transmission element 23. However, in the disclosure, a first base 35, a second base 36, and elastic components 34 are used to solve the loosening problem. Comparing with the conventional technique disposing an idler 24 in the transmission mechanism, the mechanism of the disclosure has advantages of a lower cost, a less demanded space, and a longer service life of the flexible transmission component.

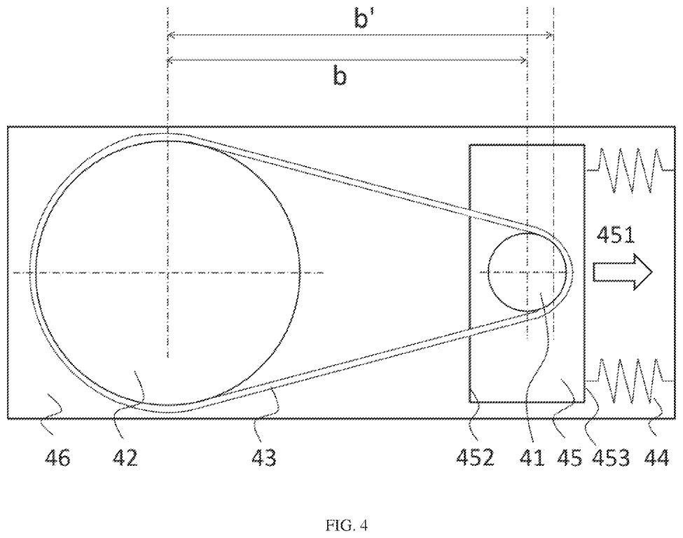

FIG. 4 represents a schematic diagram of the top view of the a transmission mechanism 4, which includes: a driver 41, a follower 42, a flexible transmission component 43, elastic elements 44, a first base 45 and a second base 46, in which a center distance (b) is defined as the distance between the center of the driver 41 and the center of the follower 42, a direction of movement 451 is defined as the direction parallel to the center distance b and away from the follower 42. The first base 45 can be divided by a fictitious median line passing through the center of the first base 45 and perpendicular to the direction of movement 451 (shown as a dot-dashed line in the figure) into two sides: a first side 452 and a second side 453, which located on the bilateral sides of the median line. The first side 452 is the side of the first base 45 closer to the follower 42, and the second side 453 is the other side of the first base 45, which is farer to the follower 42. The driver 41 is connected to the first base 45, and the follower 42 is connected to the second base 46. In this example, the second base 46 is large, and the first base 45 may be arranged on or in the second base 46. The flexible transmission component 43 is a closed loop passing around the driver 41 and the follower 42. The elastic components 44 connect the second side 453 of the first base 45 and the second base 46, and the driver 41 is arranged between the follower 42 and the elastic components 44 (as shown in FIG. 4).

In this example shown in FIG. 4, the driver 41 is the first machine element that directly receives the force and firstly rotates. The follower 42 indirectly receives the force, which is transmitted by the tension (i.e., tensile force) of the flexible transmission component 43, to rotate. The elastic components 44 connect the second side 453 of the first base 45 and the second base 46, and the elastic components 44 are in an extension status due to the forces from first base 45 and the second base 46.

In the situation that the first base 45 is moveable, when the flexible transmission component 43 loosens, the elastic components 44 will drive the first base 45 and the driver 41 connected therewith move in the direction of movement 451 and away from the follower 42 by the restoring force of the elastic components 44. At this time, a longer center distance (b′) between the center of the driver 41 and the center of the follower 42, which is longer than the original center distance (b), is formed, and the flexible transmission component 43 can adjust its tension to an adequate status at any time because of the restoring force of the elastic components 44.

In the transmission mechanism 4, since the first base 45 is arranged on or in the second base 46, the elastic components 44 connecting the first base 45 and the second base 46 are not arranged between the driver 41 and the follower 42. On the contrary, the driver 41 is arranged between the elastic components 44 and the follower 42. In other words, the elastic components 44 connect the outer side face of the first base 45 and the inner side face of the second base 46. The tension of the flexible transmission component 43 can be adjusted by adjusting the center distance between the driver 41 and the follower 42. Therefore, the transmission mechanism 4 resolves the problem that the flexible transmission component loosens in the prior art without increasing the force applied on the bending flexible transmission component.

Moreover, in the example shown in FIG. 4, the driver 41 comprises, but not be limited to, a motor, such as an electric motor or a stepper motor; the follower 42 comprises, but not be limited to, a chain wheel or a gear; the flexible transmission component 43 comprises, but not be limited to, a rope or a belt; and the elastic components 44 comprise, but not be limited to, a spring, such as a compression spring or an extension spring.

The conventional technique, such as the transmission mechanism shown in FIG. 2(a) and FIG. 2(b), arranges an idler 24 in the flexible transmission mechanism 2 to resolve the problem due to loosening of the flexible transmission element 23. However, in the disclosure, a first base 45, a second base 46, and elastic components 44 are used to solve the loosening problem. Comparing with the conventional technique disposing an idler 24 in the transmission mechanism, the mechanism of the disclosure has advantages of a lower cost, a less demanded space, and a longer service life of the flexible transmission component.

The Mechanism of the Present Disclosure can be Applied to a PTZ Camera:

The present disclosure mechanism for adjusting the tension of the flexible transmission component of the present disclosure can be applied to a pan-tilt-zoom camera (PTZ camera), as described below.

Generally, in the PTZ camera, the force of a stepper motor is transmitted to a chain wheel by a belt, in which a chain wheel and a lens are directly or indirectly connect to each other. Therefore, when the chain wheel receives the force from the stepper motor, the lens will rotate. Theoretically, when the stepper motor rotates a step (i.e., an angle); the chain wheel will correspondingly rotate a step. However, when the “tightness” of the belt is inadequate, and the belt does not mesh with the chain wheel, the sliding phenomenon will occur between the belt and the chain wheel because the rotation steps of the chain wheel are not completely equal to the rotation steps of the stepper motor (also named “out-of-step” or “losing step”). When this transmission error accumulates with time and the out-of-step is apparent on a specific step, the slippage phenomenon will occur, which means the rotation angle of the lens is less than the expected angle from the output of the stepper motor.

The term “tightness” means the tension of the belt, which is produced after the belt is passing around the stepper motor and the chain wheel. The tension of the belt results from the center distance of the stepper motor and the chain wheel (i.e., the distance between the center of the stepper motor and the center of the chain wheel).

The tension of the belt is not high enough because the assembly tolerance results in that the center of the chain wheel is not the rotation center of the chain wheel, so the center distance between the chain wheel and the driver changes over the rotation of the chain wheel, and the center distance changes slightly. The tension of the belt is not high enough because of this change.

The inadequate tension may lead to the following problem: when the stepper motor stops suddenly while the lens is rotating, the slippage phenomenon may happen due to the inertia of the lens rotation. Similarly, when the stepper motor starts suddenly while the lens is motionless, the slippage phenomenon may happen.

### The Example of the Present Disclosure Applying to PTZ Camera

In an example not shown in any accompanied figures, the transmission mechanism of PTZ camera is used to carry forward the lens. The transmission mechanism of the PTZ camera includes: a stepper motor as the driver, a chain wheel as the follower, a belt as the flexible transmission component, a compression spring as the elastic component, a moveable platform as the first base, and an immovable platform as the second base; with an original center distance between the center of the stepper motor and the center of the chain wheel; and the moveable platform has a direction of movement parallel to the original center distance and away from the chain wheel. A fictitious median line passing through the center of the moveable platform and perpendicular to the direction of movement divides the moveable platform into bilateral sides of the median line: one is the side of said moveable platform closer to said chain wheel, and the other side is the side of said moveable platform farer to said chain wheel. The moveable platform connects with said stepper motor; the immovable platform connects with said chain wheel; the belt which is a closed loop passing around said stepper motor and said chain wheel; and at least one compression spring is arranged between the side of said moveable platform closer to said chain wheel and said chain wheel. This transmission mechanism can be used to adjust the tension of the belt.

The operation of the transmission mechanism that can be used to adjust the tension of the belt in a PTZ camera is demonstrated hereinafter.

First, the belt is installed passing around the stepper motor and the chain wheel. Second, the stepper motor coverts the electricity into a driving force and rotates. And then, the chain wheel indirectly receives the force which is transmitted by the tension (i.e., tensile force) of the belt, to rotate. The compression spring is in a compression status because the force from the moveable platform and the immovable platform acts on the compression spring.

When the belt loosens, the restoring force of the compression spring will drive the moveable platform and the stepper motor connected therewith move in the direction of movement and away from the chain wheel. Therefore, a new center distance is formed between the stepper motor and the chain wheel, and the new center distance is longer than the original center distance.

Because the center distance between the stepper motor and chain wheel becomes longer, the belt passing around the stepper motor and the chain wheel as a closed loop can adjust its own tension to the most adequate status.

The mechanism can adjust the center distance between the stepper motor and chain wheel by the restoring force of the spring, so the tension of belt can be adjusted at any time, the loosening of the belt can be avoided, and the slippage phenomenon or out-of-gear phenomenon can be further prevented.

It will be understood that the aspects of the present invention will become readily apparent to those skilled in the art from the detailed description. The drawings and detailed description, especially the size, shape and distance of the machine elements, are to be regarded as illustrative in nature and not as restrictive.

We claim:

1. A mechanism for adjusting the tension of a flexible transmission component, comprising:
a driver;
a follower, with a center distance between a center of said driver and a center of said follower;
a flexible transmission component, which is a closed loop passing around said driver and said follower;
a first base connecting with said driver, wherein said first base can move in a direction of movement parallel to said center distance and away from or forward to said follower;
a second base connecting with said follower; and
at least one elastic component connecting said first base and said second base, and said at least one elastic component is arranged between said driver and said follower.

2. The mechanism according to claim 1, wherein said mechanism can be applied to a PTZ camera.

3. The mechanism according to claim 1, wherein said driver is a motor selected from an electric motor, or a stepper motor.

4. The mechanism according to claim 1, wherein said follower is a pulley or a chain wheel.

5. The mechanism according to claim 1, wherein said flexible transmission component is a rope or a belt.

6. The mechanism according to claim 1, wherein said elastic component is a spring selected from a compression spring or an extension spring.

7. The mechanism according to claim 1, wherein said first base is a moveable platform.

8. A mechanism for adjusting the tension of a flexible transmission component, comprising:
a driver;
a follower, with a center distance between a center of said driver and a center of said follower;
a flexible transmission component, which is a closed loop passing around said driver and said follower;
a first base connecting with said driver, wherein the first base can move in a direction of movement parallel to said center distance and away from or forward to said follower;
a second base connecting with said follower; and
at least one elastic component connecting said first base and said second base, and said driver is arranged between said follower and said at least one elastic component.

9. The mechanism according to claim 8, wherein said mechanism can be applied to a PTZ camera.

10. The mechanism according to claim 8, wherein said driver is a motor selected from an electric motor, or a stepper motor.

11. The mechanism according to claim 8, wherein said follower is a pulley or a chain wheel.

12. The mechanism according to claim 8, wherein said flexible transmission component is a rope or a belt.

13. The mechanism according to claim 8, wherein said elastic component is a spring selected from an extension spring or a compression spring.

14. The mechanism according to claim 8, wherein said first base is a moveable platform.
